(19) United States
(12) Patent Application Publication
(10) Pub. No.: US 2017/0006845 A1
(43) Pub. Date: Jan. 12, 2017

(54) Fishing line untwisting device

(71) Applicant: Ray Segatti, Spring Valley, IL (US)

(72) Inventor: Ray Segatti, Spring Valley, IL (US)

(21) Appl. No.: 15/203,630

(22) Filed: Jul. 6, 2016

Related U.S. Application Data
(60) Provisional application No. 62/188,962, filed on Jul. 6, 2015.

(51) Int. Cl. A01K 91/06; A01K 91/08; A01K 97/00

(52) U.S. Cl. CPC A01K 91/06; A01K 97/00; A01K 91/08

(57) ABSTRACT

A fishing line untwisting device clips or snaps onto the end of the fishing line, and provides weight in such a manner that a twisted line would tend to untwist while being reeled in by the user. The device is small, simple to use, and inexpensive.

### CROSS-REFERENCE TO RELATED APPLICATIONS

This Application claims the benefit of U.S. Provisional Application No. 62/188,962, filed Jul. 6, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to sport fishing equipment and accessories, and in particular to a fishing line untwisting device. Sport fishermen face a variety of challenges, and must be prepared to resolve them without any assistance. A twisted fishing line can be annoying, and cause the lures to behave in unnatural ways which frighten off fish rather than attracting them. The fisherman must be prepared to untwist the fishing line, which must normally be done by hand. This is laborious and time-consuming.

A search of the prior art reveals various devices which have been developed. None are closely related to the present invention, but several include features which resemble those of the present invention. Each has proven to be less than satisfactory in its own way.

Fish line untwister, U.S. Pat. No. 2,967,372 (filed Feb. 7, 1958), provides a flat piece of material, preferably metal, spirally deformed, preferably in a spiral helix, to produce a clockwise rotation or a counter clockwise rotation when pulled through the water by a line attached to a hole in the material.

Fishing line twist removal apparatus and method, U.S. Pat. No. 6,594,943 (filed Aug. 13, 2001), provides a fishing line twist removal apparatus for removing accumulated twist from a fishing line while a fishing lure is secured to the fishing line. The lure is placed into a container body having a cavity, and a slitted cap entraps the lure into the container with the fishing line extending through the slit. A plurality of blades extending outward from the container body cause the apparatus to rotate as it is pulled through water. The blades may angle for clockwise or counterclockwise rotation. A blunt nose on the apparatus allows it to skip or skim the surface of the water for reduced rotation, thereby avoiding excessive twist removal and reverse direction overtwist.

Apparatus for catching fish and removing twist from twisted fishing line, U.S. Pat. No. 5,263,277 (filed Aug. 31, 1992), provides an apparatus for attracting and catching fish while removing the twist in twisted fishing line. The device may comprise a body member that is adapted to be attached directly to the end of the twisted line. The body may be shaped such that when drawn through water it will impart a rotary motion to the twisted line or it may have fins attached thereto that cause the body to rotate in a desired direction as it is drawn through the water. A swivel is used to fasten a hook to the body and to disrupt the rotary motion that is transferred to the hook.

Fishing line twist braces and fishing rod, Japanese Patent No. 3067760 (filed Jun. 30, 1999), provides a fishing line twist braces and fishing rod able to immediately correct the twist in the fishing line. The outer peripheral surface of the correcting device main body of the fishing line twisted braces, the take-up direction of the reel is formed in the opposite direction of a helical groove.

Fishing line saver, U.S. Pat. No. 5,548,918 (filed May 30, 1995), provides a system and process for allowing a fisherman to remove kinks and twists from a fishing line by selectively applying and releasing pressure on the fishing line. The system includes a fixed restraining member which members have depending opposed surfaces that are disposed under the fishing pole in the line of the fishing line support eye loops. Both members have extensions extending above the pole with the movable member pivotally connected to an actuator rod that is supported above the pole and terminates at a position substantially opposite to and above the spool and reel. The rod includes a lever arm at its end remote form the restraining members to form an extension suitable to be reached and acted upon by preferably the thumb of the fisherman. When so acted upon, the movable member can exert a restraining pressure on the fishing line by movement toward the fixed member, causing kinks and twists in the line to be spun off toward the water.

Line twisting and untwisting attachment, U.S. Pat. No. 3,145,498 (filed Dec. 21, 1962), provides a pair of duplicate planar blades or vanes, whose inner lengthwise marginal edges are separably and adjustably mounted on diametrically opposite surfaces or sides of an intervening body. The body provides a hub which joins the blades or vanes together in relatively angled relationship. More explicitly, the device comprises a substantially rectangular block-like body having X-shaped kerfs in diametrically opposite sides, said kerfs serving to permit the coacting blades or vanes to be so positioned in relation to each other and the body to enable the device to spin or turn clockwise or counterclockwise whichever is necessary in untwisting and restoring the twisted line.

The present invention has been developed for the purpose of addressing and resolving the disadvantages of the prior art inventions. A fishing line untwisting device, which may be clipped to the line and will untwist the line with a single cast, would resolve these problems.

### SUMMARY OF THE INVENTION

Accordingly, the invention is directed to a fishing line untwisting device. The device clips or snaps onto the end of the fishing line, and provides weight in such a manner that a twisted line would tend to untwist while being reeled in by the user. The device is small, simple to use, and inexpensive.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serves to explain the principles of the invention.

FIG. 1 is a front view of the first exemplary embodiment, displaying the device 10, the spinner arms 11, the clamp 12, and the fishing line 13.

FIG. 2 is a side view of the first exemplary embodiment, displaying the device 10, the spinner arm 11, the clamp 12, and the fishing line 13.

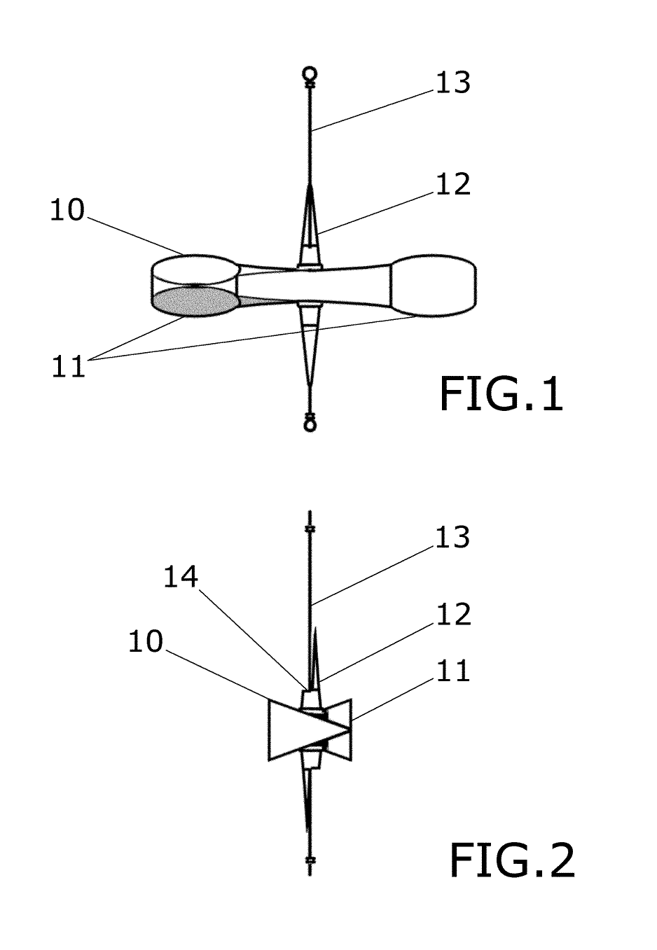

### DETAILED DESCRIPTION OF THE INVENTION

Referring now to the invention in more detail, the invention is directed to a fishing line untwisting device 10. The device 10 clips or snaps onto the end of the fishing line 13, and provides weight in such a manner that a twisted fishing line 13 would tend to untwist while being reeled in by the user. The device 10 is small, simple to use, and inexpensive.

The first exemplary embodiment provides a device 10, which is comprised of two spinner arms 11 and a central clamp 12, which is used to affix the device 10 to the fishing line 13 and an aperture 14 through which to thread the fishing line 13. The aperture is preferably six one-hundredths of an inch in diameter. The spinner arms 11 present an asymmetric configuration which creates a spinning motion, causing the fishing line 13 to untwist as the device 13 is drawn through the water. The device is preferably provided in three sizes. The small size is preferably one-sixteenth ounce in weight, the medium size is preferably three-eighths to one-half ounce in weight, and the large size is preferably one and one-half to two ounces in weight.

To use the first exemplary embodiment, the user affixes the device 10 on the fishing line 13, using the clamp 12. The user then casts the fishing line 13 and reels it in, allowing the device 10 to spin. The spinning action untwists the fishing line 13.

The device 10 is preferably manufactured from a rigid, durable material which is waterproof and easily cleaned, such as plastic, aluminum alloy, or brass.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A fishing line untwisting device, comprising: two spinner arms and a central clamp; said central clamp including an aperture through which the device may be attached to a fishing line such that a tangled fishing line is untwisted as the fishing line is drawn through the aperture.

2. The fishing line untwisting device of claim 1, wherein the spinner arms are asymmetric such that the device spins around the fishing line when drawn through water.

3. The fishing line untwisting device of claim 1, wherein the aperture is six one-hundredths of an inch in diameter.

4. The fishing line untwisting device of claim 2, wherein the aperture is six one-hundredths of an inch in diameter.

5. The fishing line untwisting device of claim 1, wherein the spinner arms present an asymmetric configuration which creates a spinning motion, causing the fishing line to untwist as the device is drawn through the water.

6. The fishing line untwisting device of claim 2, wherein the spinner arms present an asymmetric configuration which creates a spinning motion, causing the fishing line to untwist as the device is drawn through the water.

7. The fishing line untwisting device of claim 3, wherein the spinner arms present an asymmetric configuration which creates a spinning motion, causing the fishing line to untwist as the device is drawn through the water.

8. The fishing line untwisting device of claim 4, wherein the spinner arms present an asymmetric configuration which creates a spinning motion, causing the fishing line to untwist as the device is drawn through the water.

9. The fishing line untwisting device of claim 1, wherein the device is one of a small size weighing one-sixteenth of an ounce, a medium size weighing between three-eighths of an ounce and one-half of an ounce, or a large size weighing between one and a half ounces and two ounces.

10. The fishing line untwisting device of claim 2, wherein the device is one of a small size weighing one-sixteenth of an ounce, a medium size weighing between three-eighths of an ounce and one-half of an ounce, or a large size weighing between one and a half ounces and two ounces.

11. The fishing line untwisting device of claim 5, wherein the device is one of a small size weighing one-sixteenth of an ounce, a medium size weighing between three-eighths of an ounce and one-half of an ounce, or a large size weighing between one and a half ounces and two ounces.

12. The fishing line untwisting device of claim 6, wherein the device is one of a small size weighing one-sixteenth of an ounce, a medium size weighing between three-eighths of an ounce and one-half of an ounce, or a large size weighing between one and a half ounces and two ounces.

13. The fishing line untwisting device of claim 7, wherein the device is one of a small size weighing one-sixteenth of an ounce, a medium size weighing between three-eighths of an ounce and one-half of an ounce, or a large size weighing between one and a half ounces and two ounces.

14. The fishing line untwisting device of claim 8, wherein the device is one of a small size weighing one-sixteenth of an ounce, a medium size weighing between three-eighths of an ounce and one-half of an ounce, or a large size weighing between one and a half ounces and two ounces.
